(19) United States
(12) Patent Application Publication
(10) Pub. No.: US 2013/0182824 A1
(43) Pub. Date: Jul. 18, 2013

(54) SAMPLE ANALYSIS SYSTEM

(71) Applicants: Peter W. French, Sydney (AU); Gary L. Corino, Sydney (AU)

(72) Inventors: Peter W. French, Sydney (AU); Gary L. Corino, Sydney (AU)

(21) Appl. No.: 12/598,914

(22) PCT Filed: May 2, 2008
(86) PCT No.: PCT/AU08/00602

§ 371 Date: Mar. 3, 2010

(30) Foreign Application Priority Data
May 4, 2007 (AU) 2007902369

(51) Int. Cl. G01N 23/20

(52) U.S. Cl. CPC G01N 23/20025
USPC 378/79

(57) ABSTRACT

A hair sample analysis system; said system comprising multiple sample arrays located within a container, an automated drive mechanism for removing an individual array from said container and for urging a. hair sample of said sample array to a first approximate location, and a monitoring and control system, for adjustment of said drive mechanism to locate said hair sample into substantial coincidence with an X-ray diffraction beam; locating said sample in substantial coincidence with said X-ray diffraction beam; irradiating said sample with said beam for a predetermined time; receiving and storing for analysis data derived from said step of irradiating said hair sample; repeating said steps for a consecutive one of said hair 5 samples from said sample array; returning said sample array to its original location in said container and removing another array from said sample container and repeating said steps for consecutive arrays.

The present invention relates to X-ray diffraction and, more particularly, to the mounting and aligning of hair samples for X-ray diffraction analysis for the purpose of diagnosis of disease.

### BACKGROUND

In 1999 James and colleagues reported differences in the small angle X-ray scatter (SAXS) patterns of hair from individuals with breast cancer compared to healthy subjects¹. The SAXS patterns of hair from cancer patients contained a ring of comparatively low intensity which was superimposed on the normal alpha-keratin pattern obtained from healthy control subjects. A detection technique based on these observations is the subject of U.S. Pat. No. 6,718,007. This ring was reportedly observed in all samples of scalp and/or pubic hair taken from women diagnosed with breast cancer, as well as from subjects “not yet diagnosed with breast cancer but suspected of being at risk”. In other words, a number of false positives were identified. Subsequent papers by James and colleagues reported SAXS analysis results of blinded human samples which were consistent with the initial publication^{2,3}. The later paper reported on the results of 503 blinded hair sample analyses and demonstrated a sensitivity of 100% (no false negatives) and a specificity of 86% (14% false positives by comparison to mammography) for breast cancer.

However, the finding remains highly controversial as several groups independent of James have attempted to replicate the original findings and all were unsuccessful⁴⁻¹¹. James responded by publishing technical explanations for their replication failures. The German-Austrian⁹ group sent the 27 samples they had examined to James who subsequently analysed them in a blinded study. The results showed that all the breast cancer samples had been identified correctly². James has consistently claimed that in most cases other groups failed to confirm her findings because of their inability to produce the basic characteristic reflections of alpha-keratin in their SAXS images of human hair^{12,13}. She has cited as a prime example of acceptable data those published in 1995 by Wilk et al¹⁷. This publication also described the methodology required to process the data and listed a considerable number of variables making this experiment technically difficult to replicate. Prime factors that must be taken into account include: the method of sample collection, the physical state of the hair, the amount of tension with which the hair sample is held in the X-ray beam, the actual positioning of the fibre in the beam and the method of image analysis and the interpretation of data¹⁵.

Further data supporting the finding was presented by James and colleagues using an animal model of breast cancer³. To correlate the observed change with the presence of breast cancer, whiskers removed from nude mice prior to, and 8 weeks post, subcutaneous implantation of a human breast adenocarcinoma cell line were analysed using SAXS. The post-implantation whiskers showed the presence of a ring in the SAXS pattern, similar to that seen for human subjects affected by breast cancer. This data also indicated that the ring appeared within two weeks of cancer cell implantation, and before a visible tumor was formed. This provided further evidence that the alteration observed in the SAXS pattern of hair could be an early marker for the presence of cancer.

In 2005, a study of hairs from cancer and normal subjects by Fourier transform infrared attenuated total reflection (FTIR-ATR) provided independent validation of the underlying hypothesis that hair from individuals with breast cancer exhibits a structural abnormality²⁴. When the FTIR-ATR spectra of hairs from subjects with cancer were compared with the spectra of hairs from non-cancer subjects, differences in the amide I region [1750-1450 cm−1] and the C-H overtone region [1500-1300 cm−1] were observed. Interpretation of the spectra of these regions modification of the hair fibre growth as a result of the presence of a developing cancer. The changes in the amide I region were indicative of an increase in beta-sheet disorder content compared to α-helical structures. The changes in the C-H overtone region were suggestive of an increase in lipid content. When unknown samples were analysed by reference to these two regions of the resulting spectra, the researchers were able to correctly identify all of the cancer patients. It is interesting to note that there were two false positives.

In 2006, Lawson and Tran demonstrated that molecules such as estrogen receptor alpha, progesterone receptors, Bcl-2 and Her-2/neu which are up-regulated in breast tumors are. also up-regulated in skin from the same patient²⁵. On the basis of these results they proposed that the influence of discrete breast cancers is systemically expressed and leads to changes in skin and hair, thus supporting the underlying hypothesis of James and colleagues. They proposed this mechanism because, breasts are specialized sweat glands which are epithelial in origin, hair also is epithelial in origin and estrogen and other hormones are metabolized in skin and hair follicles.

It has been proposed that the origin of the ring present in the SAXS images of hair from individuals with breast cancer comes from a variation in the structure of the cell membrane of the fibre as it is assembled in the folliclel. It has also been proposed that an “additional component” could theoretically bind to the alpha-keratin fibres forming in the intermediate filaments or to other structural elements such as the lipid bi-layers²⁶. If an additional component is incorporated into the structural elements of the fibre during biosynthesis, then it is conceivable that this additional material can be extracted from the fibre. It is also conceivable that removal of any extraneous material from the fibre would return its diffraction pattern to look like that of a normal hair.

Until now, all studies have aligned the hair fibres in the beam manually. The procedure for mounting and aligning a hair sample manually is described below:
An operator places a hair fibre into a sample holder, applying sufficient tension on the fibre to ensure that it is held straight, but not sufficient tension to stretch the fibre. Ten such samples are mounted per sample holder
The operator mounts the sample holder onto the positioning device. Whilst watching the CCD image on the monitor, the operator moves the hair fibre into the approximate position by entering the co-ordinates into the computer that drives the motorized stage.
A brief exposure is taken, and the diffraction image is used to determine if the sample is aligned within the beam. If not, further adjustments are made to the X and Y co-ordinates on the computer.
After the sample has been centered, analysis of the sample by X-ray diffraction is carried out, and the resulting image analysed for the presence of the feature indicative of disease.
   Clearly this is a very tedious and time consuming process, reliant on the skill and vigilance of individual operators and is unsuited for any large scale screening program.

It is an object of the present invention to address or at least ameliorate some of the above disadvantages.

### REFERENCES

1. James V, Kearsley J, Irving T, Amemiya Y and Cookson D. Using hair to screen for breast cancer. Nature 1999; 398:33-34.

2. Meyer P and James V J. Experimental confirmation of a distinctive diffraction pattern in the hair from women with breast cancer. J Nat Cancer Instit. 2001; 93(11):873-875.

3. James V, Corino G, Robertson T, Dutton N, Halas D, Boyd A, Bentel J and Papadimitriou J. Early diagnosis of breast cancer by hair diffraction. Int J Cancer. 2005; 114:969-72.

4. Briki F, Busson B, Salicru B, Esteve F and Doucet J. Breast Cancer Diagnosis using hair. Nature 1999; 400:236.

5. Amenitsc H, Rappolt M, Laggner P, Bemstorff S, Moslinger R, Fleischmann E, Wagner T, Lax S, Petru E, Hudabiunlgg K and Della Palma L. Synchrotron X-ray study at Trieste: No correlation between breast cancer and hair structure. Synchrotron Rad News 1999; 12:32-34.

6. Schroer K, DeRisis D, Kastrow K, Busch E, Volkow N and Capel M. Hair Test Results at the NSLS Synchrotron Radiat News. 1999; 12:34-35.

7. Chu B, Fang D and Hsiao BS. 1999 Hair Test Results at the Advanced Polymer Beamline (X27C} at the NSLS. Synchrotron Radiat News. 1999; 12:36.

8. Howell A, Grossman J G, Cheung K C, Kanbl L, Evans D G and Hasnain S S. Can hair be used to screen for breast cancer? J Med Genet. 2000; 37:297-298.

9. Meyer P, Goergl R, Botz J W, Fratzl P. Breast Cancer Screening Using Small-Angle X-Ray Scattering Analysis of Human Hair. J Natl Cancer Inst. 2000; 92(13):1092-1093

10. Aksirov A M, Gerasimov V S, Kondretyev V I, Korneev V N, Kulipanov G N, Lanina N F, Letyagin V P, Mezentsev N A, Sergienko P M, Tolochko B P, Trounova V A and Vezina AA. Biological and medical application of SR from the storage rings of VEPP-3 and “Siberia-2”, The origin of specific changes of small-angle X-ray diffraction pattern of hair and their correlation with the elemental content, Nucl Instrum Meth Phys Res A. 2001; 470:380-7.

11. Laaziri K, Sutton M, Ghadirian P, Scott A S, Paradis A J, Tonin P N, Foulkes W D. Is there a correlation between the structure of hair and breast cancer or BRCA1/2 Mutations? Phys Med Biol 2002; 47:1623-1632.

12. James V. Comments on the statements and experiments contained in this review. Synchrotron Rad News 1999; 12:32-3.

13. James V. The importance of good images in using hair to screen for breast cancer. J Med Genet 2001; 38:e16,1.

14. James V. False-positive results in studies of changes in fiber diffraction of hair from patients with breast cancer may not be false. J Natl Cancer Inst. 2003; 95:170-1.

15. James V J. The traps and pitfalls inherent in the correlation of changes in the fibre diffraction pattern of hair with breast cancer. Phys Med Biol. 2003; 48:L5-9.

16. James V J. Changes in the diffraction pattern of hair resulting from mechanical damage can occlude the changes that relate to breast cancer. Phys Med Biol. 2003; 48:L37-41.

17. Wilk K, James V, and Amemiya Y. Intermediate Filament Structure of Human Hair. Biophysica Biochimica Acta. 1995; 1245: 392-396.

18, Hart M. Using hair to screen for breast cancer. Synchrotron Rad News. 1999; 12:32.

19. Evans D G R, Howell A, Hasnain S S and Grossmann J G. Science or black magic? J Med Genet. 2001; 38:e16, 2.

20. Sutton M, Laaziri K and Koulkes W D. Response to “The traps and pitfalls inherent in the correlation of changes in the fibre diffraction pattern of hair with breast cancer”. Phys Med Biol. 2003; 48:L11-13.

21. Rogers K D, Hall C J, Hufton A, Wess T J, Pinder S E and Siu K. Reproducibility of cancer diagnosis using hair. Int J Cancer. 2006; 118:1060.

22. James V J. Reply to the letter of Rogers et al. entitled “Reproducibility of Cancer Diagnosis Using Hair”. Int J Cancer. 2006; 118:1061-2.

23. James V J. Fibre diffraction from a single hair can provide an early non-invasive test for colon cancer. Med Sci Monit. 2003; 9:MT79-84.

24. Lyman D J. and Murray-Wijelath J. Fourier Transform Infrared Attenuated Total Reflection analysis of human hair: Comparison of hair from breast cancer patients with hair from healthy subjects. Appl Spectroscopy. 2005; 59:26-32.

25. James V J. A place for fiber diffraction in the detection of breast cancer? Cancer Det Prev. 2006; 30:233-8.

26. Fischetti R, Stepanov S, Rosenbaum G, Barrea R, Black E, Gore D, Heurich R, Kondrashkina E, Kropf A J, Wang S, Zhang K, Irving T C and Bunker G B. The BioCAT undulator beamline 181D; a facility for biological non-crystalline diffraction and X-ray absorption spectroscopy at the Advanced Photon Source. J Synchrotron Radiat. 2004; 11:399-405.

### Notes

1. The term “comprising” (and grammatical variations thereof) is used in this specification in the inclusive sense of “having” or “including”, and not in the exclusive sense of “consisting only of”.

2. The above discussion of the prior art in the Background of the invention, is not an admission that any information discussed therein is citable prior art or part of the common general knowledge of persons skilled in the art in any country.

### BRIEF DESCRIPTION OF INVENTION

Accordingly in one broad form of the invention there is provided a method for automatically aligning a sample comprising a hair fibre within an x-ray beam, said sample mounted on a positioning device, said method comprising the steps of:
(a) providing a sample, said sample mounted on a sample holding device consisting of provision for multiple separate samples to be mounted, each sample being unique;
(b) providing an apparatus capable of viewing said mounted sample, whereby said apparatus is capable of imaging said mounted sample, reading the bar code and determining coordinates of said sample relative to a reference position, wherein no portion of said sample mounted in said positioning device is initially at said reference position;
(c) providing a source of power for adjusting said positioning device linearly along two orthogonal axes; and
(d) activating said source of power to cause said positioning device to be adjusted such that said sample is positioned into the path of a beam of X-rays.

Preferably said viewing apparatus is a CCD camera.

Preferably said source of power comprises at least one motor.

In a further broad form of the invention there is provided a method for conducting single or multiple X-ray diffraction analysis on a sample selected from a plurality of samples, said sample consisting of a hair fibre, said method comprising the steps of:
(a) collecting a hair from a subject using a sample collection device;
(b) transporting the sample collection device containing the hair samples to an analysis facility;
(c) mounting the hair in a sample holder;
(d) providing a positioning device for mounting said sample holder so that said sample can be positioned in the path of a beam of X-rays;
(e) providing an apparatus capable of viewing said mounted sample, whereby said apparatus is capable of imaging said mounted sample and determining coordinates of said sample relative to a reference position, wherein no portion of said sample mounted in said positioning device is initially at said reference position;
(f) providing a source of power for adjusting said positioning device linearly along two or more orthogonal axes;
(g) activating said source of power to cause said positioning device to be adjusted such that said sample is positioned into the path of a beam of X-rays;
(h) providing a beam of X-rays, said beam aimed at said sample; and
(i) recording scattering of X-rays from said sample.

Preferably said positioning device is a rack connected to a motorized armature capable of movement in two or more planes

Preferably said sample holder is mounted to said positioning device by means of screws, clamps or clips.

Preferably said viewing apparatus is a CCD camera.

Preferably a computer is employed to automate said method.

Preferably a computerized detection system is employed to record scattering of X-rays from said sample.

Preferably said source of power comprises at least one motor.

In yet a further broad form of the invention there is provided a sample analysis system; said system comprising at least one sample array, an automated drive mechanism for urging a sample of said sample array to a first approximate location, and a monitoring and control system for adjustment of said drive mechanism to locate said sample into substantial coincidence with an X-ray diffraction beam.

Preferably said sample array comprises a number of discrete hair fibres retained in hair fibre holding means provided on a hair sample holding device; at least a portion of each of said fibres located in a common plane.

Preferably said sample holding device comprises a plate of rigid material; said plate provided with a hole or slot to allow the transmission of diffracted x-rays; said hole or slot being bordered by raised ridges projecting from an outer face of said plate of rigid material; said ridges arranged along opposing elongate sides of said slot; said raised ridges each containing a groove of around 100 um width; said groove to be used as a guide to align a hair over said hole.

Preferably said hair fibre holding means include multiple holes and ridges on the same plate. For convenience, the said plate has the dimensions of a standard microscope slide (25 mm in width and 75 mm in length).

Preferably said hair fibre holding means include strips of adhesive disposed at intervals along said opposing elongate sides of said slot; a first one arranged along one side of said hole and a second, third and fourth adhesive strip arranged on the opposite side of said hole at regular intervals.

Preferably each of said hair fibre holding means is associated with a subject-identifying bar code label in addition to a hair fibre identifying bar code label.

Preferably said at least one sample array is one of a number of sample arrays retained in a sample array rack; said sample array rack supported on slide-ways adapted to allow translation of said sample array rack in two or more mutually orthogonal directions; said two mutually orthogonal directions lying in a plane parallel to said common plane and normal to said X-ray diffraction beam.

Preferably said sample array rack is urged into said two mutually orthogonal directions by servomotors of a computerized drive mechanism; said servomotors driving said sample array rack so as to position a said hair fibre at a said first approximate location between an X-ray beam emitter and an X-ray beam recording device.

Preferably said first approximate location of a said hair fibre is compared to an optimum hair fibre location by means of an imaging system; said imaging system including software providing output to said computerized drive mechanism to position said middle portion of said hair fibre in substantial coincidence with said X-ray diffraction beam.

Preferably said X-ray beam recording device is coupled to a computer for recording and analysing scattering of X-rays from interaction of said X-ray diffraction beam.

Preferably said recording device is a MAR detector. Preferably said imaging system includes a CCD camera focussed on said optimum hair fibre location at a point where said X-ray diffraction beam intersects said common plane.

Preferably said system further includes a bar code reader; said bar code reader providing input to said computer for correlating a said hair fibre sample with a provider of said sample.

In yet a further broad form of the invention there is provided a method of analyzing a keratin sample in the form of hair from a patient so as to improve sensitivity and specificity of a diagnostic test associated with a pathological state in the patient comprising: aligning the sample in accordance with the method of any of claims 1 to 10, then

a) exposing the keratin sample to incident energy derived from an energy source;

b) receiving radiated energy from the keratin sample consequent upon impingement of the incident energy on the keratin sample;

c) passing at least a portion of the radiated energy received from the keratin sample through a transducer so as to derive data;

d) comparing the data derived with a second group of data present in a reference database;

wherein the second group of data is consistent with a presence of the pathological state in the patient.

Preferably the second group of data is correlated with the presence of the pathological state in the patient.

Preferably the second group of data is causatively associated with the presence of the pathological state in the patient.

Preferably the energy source is selected from a plurality of different energy sources.

Preferably the keratin sample is selected from a plurality of different keratin samples.

Preferably the second group of data is selected from a plurality of different data groups of data.

Preferably the derived data and the second group of data are analyzed using a plurality of different methods of comparison.

Preferably at least a portion of the incident energy is absorbed by the keratin sample.

Preferably in use, the keratin sample can be obtained and analyzed in association with at least one of a pharmacy, a test kit, the patient's home, a health care clinic or a pathology collection centre and a testing laboratory.

Preferably said data is in the form of image data of an image derived from said transducer; said method of analysis comprising;

(a) extracting one-dimensional data along predetermined paths in said image so as to determine spacing of features in said image

(b) defining substantially circular-oriented peak data about a centre point of said image from an analysis of said one-dimensional data

(c) applying intensity correction to said substantially circular-oriented peak data so as to better define said circular-oriented peak data as it appears in said image.

In yet another broad form of the invention there is provided a sample analysis system; said system comprising at least one sample array, an automated drive mechanism for urging a sample of said sample array to a first approximate location, and a monitoring and control system for adjustment of said drive mechanism to locate said sample into substantial coincidence with an X-ray diffraction beam; locating said sample in substantial coincidence with said X-ray diffraction beam; irradiating said sample with said beam for a predetermined time; receiving and storing for analysis data derived from said step of irradiating said sample; repeating said steps for a consecutive one of said samples from said sample array.

In yet another broad form of the invention there is provided a sample analysis system; said system comprising multiple sample arrays located within a container, an automated drive mechanism for removing an individual array from said container and for urging a sample of said sample array to a first approximate location, and a monitoring and control system for adjustment of said drive mechanism to locate said sample into substantial coincidence with an X-ray diffraction beam; locating said sample in substantial coincidence with said X-ray diffraction beam; irradiating said sample with said beam for a predetermined time; receiving and storing for analysis data derived from said step of irradiating said sample; repeating said steps for a consecutive one of said samples from said sample array; returning said sample array to its original location in said container and removing another array from said sample container and repeating said steps for consecutive arrays.

### BRIEF DESCRIPTION OF DRAWINGS

Embodiments of the present invention will now be described with reference to the accompanying drawings wherein:

FIG. 1 is a general schematic diagram of an arrangement of a sample analysis apparatus for aligning a hair sample with an X-ray beam emitter and detector, with associated control and diagnostic output components,

FIG. 2 is a front view of a hair sample holding is device for mounting in a carrier rack of the apparatus of FIG. 1,

FIG. 3 is a sectioned side view of the hair sample holding device and carrier rack of FIG. 2, showing portions of the X-ray beam emitter and X-ray beam recording device.

FIG. 4 is a block diagram of the sample analysis system to which the automated positioning technique can be applied.

FIG. 5 is a block diagram of the full analysis system from patient collection through to automated test and supplied results.

FIG. 6 is a comparison of the output of a first and second image processing protocol to which the automated technique of the present invention has been applied.

FIG. 7 is a front view of an alternative embodiment of a hair sample holding device for mounting in a carrier rack of the apparatus of FIG. 1

### DETAILED DESCRIPTION OF PREFERRED EMBODIMENTS

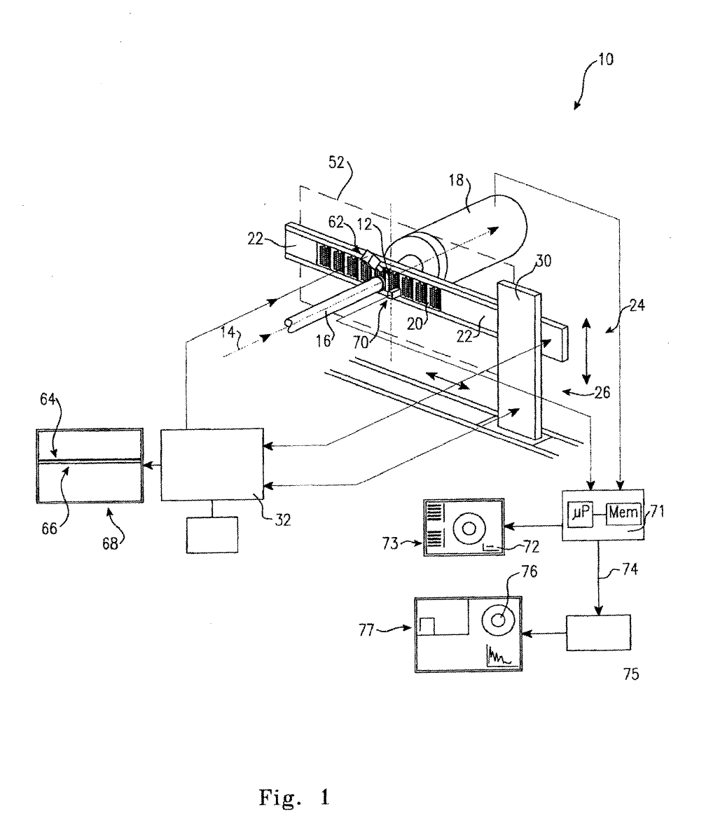

With reference to FIG. 1, a hair sample analysis system 10 is arranged to locate each of a number of discrete hair fibre samples 12 coincident with an X-ray diffraction beam 14 from X-ray beam emitter 16. Scattering of the X-ray beam 14 as a result of interference from a hair fibre sample 12 is received by MAR detector 18.

Sample arrays of hair fibre samples 12 are retained on a number of hair sample holding devices 20, supported in a sample array rack 22. Rack 22 is mounted on a positioning device 24 which is provided with a computerized drive mechanism 26. Drive mechanism 26 is comprised of a horizontal slide 28 and a vertical slide 30 to provide X-X and Y-Y translation of rack 22. positioning device 24 is controlled by a positioning computer 32 adapted to move a hair fibre 12 sample in a plane normal to the X-ray diffraction beam 14.

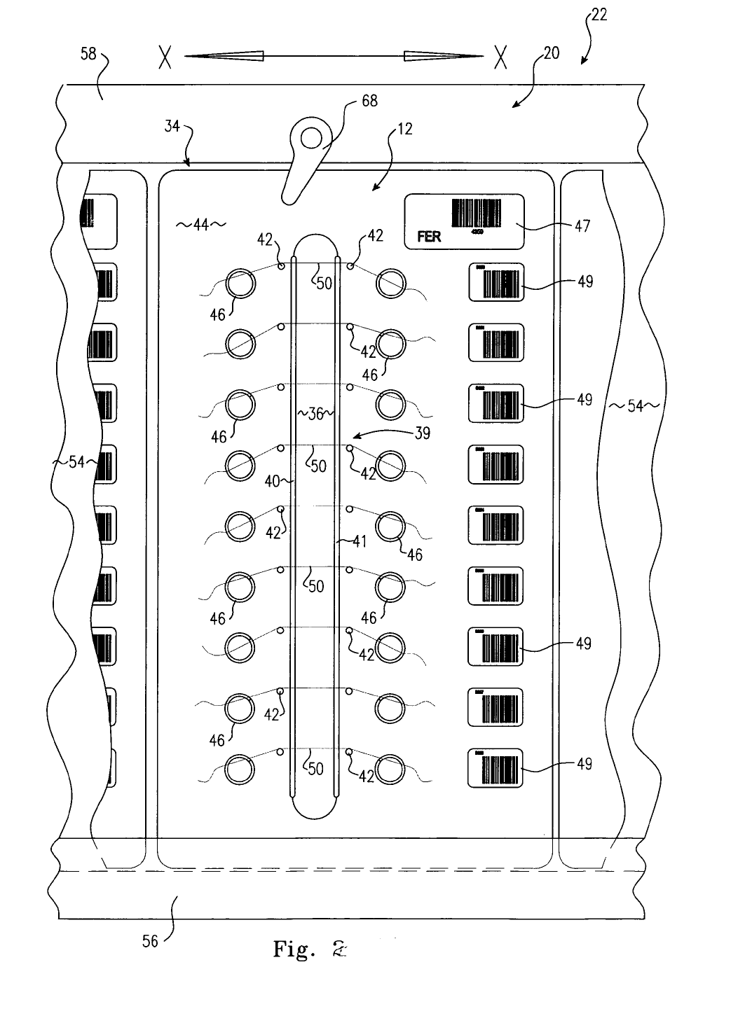

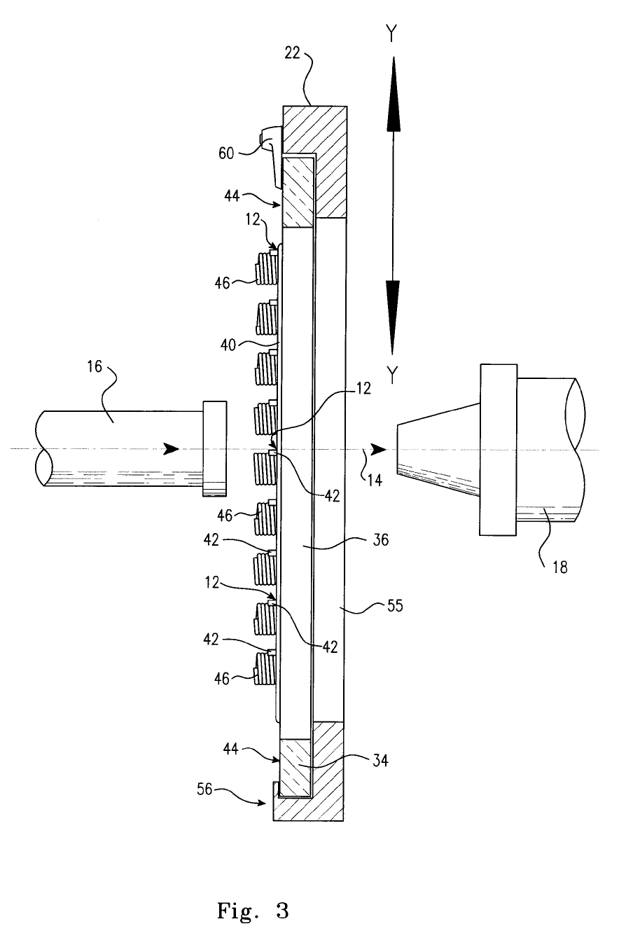

Turning now to FIGS. 2 and 3, an array of hair fibre samples 12 is retained in a hair sample holding device 20. Holding device 20 comprises a plate of rigid, preferably transparent material 34 provided with a vertically aligned central elongate slot 36. Arranged along the opposing elongate sides 38,39 of slot 36, are raised ridges 40 and 41 respectively. At intervals along the length of slot 36 are pairs of support posts 42; one of each pair arranged adjacent side 38 and the other adjacent side 39 of slot 36. Support posts 42 project from the outer face 44 of plate 34 sufficient to extend beyond raised ridges 40 and 41, as best seen in FIG. 3.

Holding device 20 is further provided with pairs of tightly wound extension coil springs 46, one pair for each pair of support posts 42, and likewise arranged with a first of a pair of coil springs located at one side of slot 36 and the other at the opposite side.

Discrete hair fibre samples 12 are retained on holding device 20 by securing one end of a hair fibre 12 between the adjoining coils of a first coil spring 46, stretching the fibre over the pair of support posts 42 and securing the other end of the hair fibre between the coils of the coil spring at the opposite side of slot 36. Ends of hair fibre 12 are secured in coil springs 46 at a level closer to the outer surface 44 of rigid plate 34 then the outer surface of raised ridges 40 and 41, so that the fibre is also stretched over these ridges. The effect is that the sample array forms a parallel series of middle portions 50 of hair fibres 12 lying in a common plane 52 normal to the X-ray diffraction beam 14.

Realeasably affixed to holding device 20 is a bar code label 47 identifying the holding device and providing batch information. Bar code labels 49 are further provided alongside each hair fibre sample 12. These bar codes labels 49 are released from the packaging (not shown) in which the hair sample was collected and affixed to the holding device, as a hair fibre sample is added to the array.

Sample array rack 22 comprises a rigid back plate 54 with a lower rail 56 and top rail 58. Rigid back plate 54 is provided at intervals with slots 55, equal to or slightly larger than slots 36 in holding devices 20. Holding devices 20 are retained on array rack 22 by sliding engagement in lower rail 56 and by clips 60 arranged at appropriate intervals along top rail 58, and so that slots 36 of holding devices 20 are aligned with slots 55.

Referring now again to FIG. 1, the positioning device 24 under control of the positioning computer 32 initially directs the X-X servomotor to drive the sample array rack 22 to a position where an operator may load previously prepared holding devices 20 into the sample array rack. The positioning computer then drives the rack in both X-X and Y-Y directions in a first positioning sequence, which brings the first hair fibre sample of the first holding device into an approximate alignment position. This position is such that the vertical axis of first slot 58 in array rack 22 is coincident with the calibrated axis of the X-ray diffraction beam emitter 16, and brings the first hair fibre sample also proximate this axis.

Positioning computer 32 now receive image data from an imaging system camera 62, focussed on the point of intersection of the common plane 52 and the axis of the X-ray diffraction beam emitter. The camera 62 monitors the position of the hair fibre sample and the positioning computer compares the location of the fibre's image 64 with a horizontal reference line 66 as shown on display 68. Reference line 66 is representative of the optimum position of the fibre; that is when the middle portion 50 of the fibre is coincident with or intersected by the axis of the X-ray beam. The positioning computer 32 uses the difference in position to command the Y-Y servomotor to bring the image of the hair fibre sample into coincidence with the reference line.

The X-ray diffraction beam and detector, system is then activated to record and process the scattering of the X-ray beam as it interacts with the hair fibre sample. The recording is correlated with a reading of the associated bar code of the sample by bar code reader 70 mounted adjacent to the beam emitter 16.

The MAR detector 18 outputs its signal to first diffraction data processor 71 from which an initial raw diffraction image 72 is processed and can be displayed on raw diffraction image display 73. The raw diffraction image data 74 is then fed to a second diffraction data processor 75 at which point image enhancement techniques are applied, resulting in display of enhanced diffraction image 76 on enhanced image display 77.

### Sample Holding Device—Second Embodiment

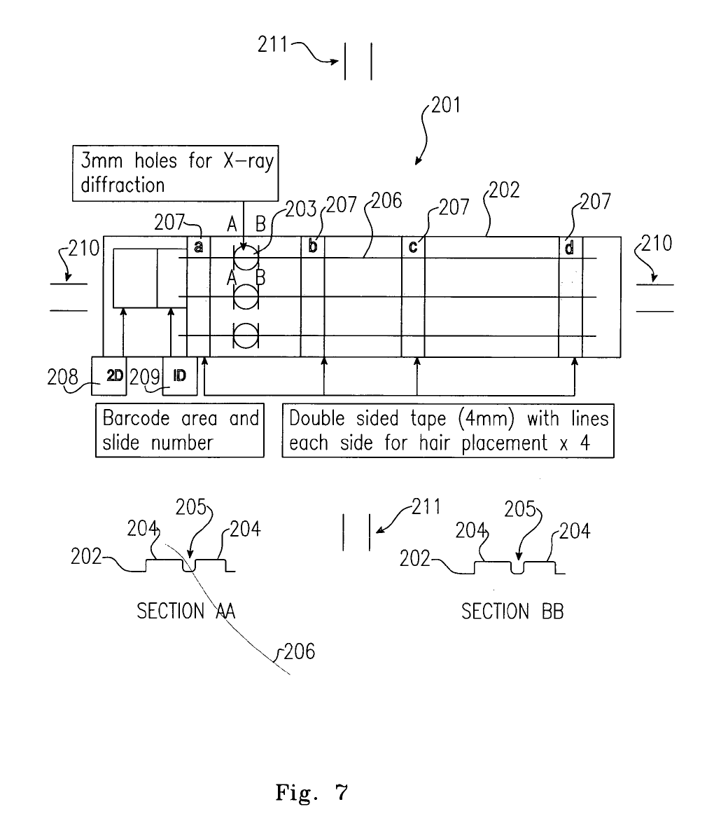

An alternative form of the sample array rack 22 of FIG. 2 is illustrated in FIG. 7.

In this embodiment the sample array rack or sample holding device 201 comprises a plate 202 of rigid material. The plate 202 is provided with a hole or slot 203 to allow the transmission of diffracted x-rays. In this embodiment each hole or slot 203 is bordered by raised ridges 204 projecting from an outer face of said plate of rigid material (refer section AA and BB). The ridges 204 are arranged along opposing elongate sides of said slot (refer section AA and BB). The raised ridges each contain a groove 205 of around 100 um width. The groove is used as a guide to align a hair 206 over said hole.

Preferably the sample array rack or sample holding device 201 includes multiple holes and ridges on the same plate. In a preferred form the plate has the dimensions of a standard microscope slide (25 mm in width and 75 mm in length).

Preferably the sample array rack or sample holding device 201 includes strips of adhesive 207 disposed at intervals along opposing elongate sides of said slot; a first one arranged along one side of said hole and a second, third and fourth adhesive strip arranged on the opposite side of said hole at regular intervals.

Preferably each of the sample array rack or sample holding device 201 is associated with a subject-identifying bar code label 208 in addition to a hair fibre identifying bar code label 209.

Preferably the at least one sample array is one of a number of sample arrays retained in the sample array rack or sample holding device 201. In a preferred form said sample array rack is supported on slide-ways 210,211 adapted to allow translation of said sample array rack in two or more mutually orthogonal directions. In this embodiment the two mutually orthogonal directions lie in a plane parallel to the common plane and normal to the X-ray diffraction beam.

Two possible image enhancement techniques will be described below which are suited for use with the automation technique described above.

### ANALYSIS TECHNIQUE

Definitions:

“Radiate”: To proceed in direct lines from a point or surface.

“Mammalian species” includes the types of species as appearing in the body of the specification.

“Energy source” includes the types of energy as appearing in the body of the specification.

A “keratin sample” is a sample that is substantially comprised of keratin.

The plurality of different selections and forms pertaining to the invention as claimed include the selections and forms as appearing in the body of the specification.

Unless otherwise indicated by the context, a claim to one element is consistent with a claim to at least one element.

Embodiments of the present invention will now be described with reference to the accompanying drawings wherein;

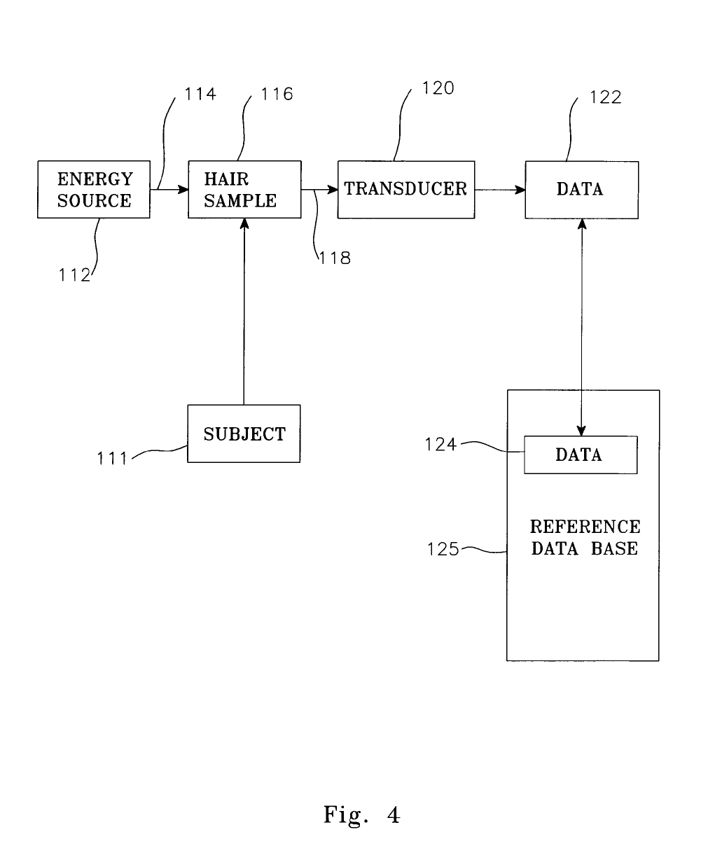

FIG. 1 illustrates a method of analyzing a keratin sample 116. FIG. 4 shows an energy source 112 from which incident energy 114 emanates. A keratin sample 116 is taken from patient 111. The patient 111, includes a mammalian species. A mammalian species can include a human, a pet such as a dog or cat or a variety of other animals. The keratin substance 116 can include human scalp or body hair and in particular pubic hair, pet hair, animal hair or hair from a mammalian species in general, or other keratin based materials such as nail clippings or an eyelash.

The keratin sample 116 is exposed to the incident energy 114. Radiated energy 118 is derived from the keratin sample 116 consequent upon impingement of the incident energy 114 on the keratin sample 116.

At least a portion of the radiated energy 118 is passed through a transducer 120 to produce data 122. The data 122 can be compared with data 124 in a reference database 125 to determine whether or not the patient 111 can have a pathological state (for example if the reference database 125 indicates that the result in question is both correlated and causatively associated with the pathological state then a meaningful comparison can be considered, additionally zero correlation or no information being provided in the case of complete absorption of the incident radiation can also provide useful analytical information).

### In Use

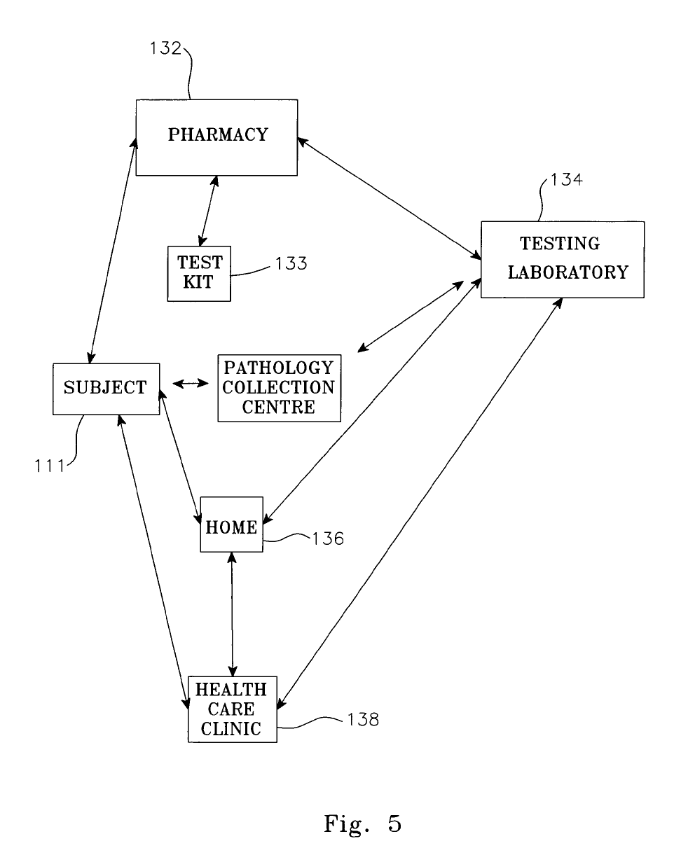

FIG. 5 shows an embodiment of the present invention in use In FIG. 5 a patient 111 can attend a pharmacy 132 to provide a hair sample 116. The hair sample 116 can then be sent to a testing laboratory 134 so as to perform the method of analyzing the hair sample 116 as seen in FIG. 4.

Additionally, the patient 111 can obtain a test kit 133 from their pharmacy so as to use the test kit 133 embodying the method of analyzing the hair sample 116 in the patient's home 136, in association with consultation of the patient's health care practitioner at a health care clinic 138.

Alternatively, the patient 111 can visit his or her health care clinic 138 so as to provide the hair sample 116. The health care clinic 138 can perform the method of analyzing the hair sample 116 or forward the hair sample to the testing laboratory 134.

### Further Embodiment

A preferred image analysis method has been trialed and is described below:

### Sample Collection and Handling

Hair samples (scalp and/or pubic) of at least 30 mm in length were collected from women referred to an Australian radiology clinic for a mammogram. Women were excluded if their scalp hair had been dyed or chemically treated (such as permanent waving) within the previous 6 weeks and if their pubic hair was unavailable, or had a history of breast cancer or other cancers (excluding non-melanoma skin cancer and CIN: cervical intra-epithelial neoplasia) within 5 years. Nineteen blinded hair samples were collected at the clinic and these samples together with 14 samples from women diagnosed with breast cancer and six samples from women assumed negative by mammography, were analysed in this study.

Scalp hairs were taken from the region behind the ear, close to the hair line, and removed by cutting as close to the skin as possible. This was done to ensure the samples taken had minimal damage from environmental factors. Pubic hairs were also removed by cutting as close to the skin as possible and all hair samples were stored in plastic specimen containers. All patient medical histories were kept on file at the clinic.

Synchrotron Small Angle X-Ray Scatter (SAXS) analysis required a single hair to be gently removed from the container using fine forceps and loading it onto a specially designed sample holder that is capable of holding 10 individual hair fibers. These holders use tine springs to grasp a fiber and pins to locate the fibre in the appropriate orientation for the X-ray beam. When it could be identified, the cut end of the fiber was loaded first by opening the coils of a spring on one side of the holder and placing the fiber between the coils. The spring was then allowed to relax to clamp the fiber. The coils of the spring opposite were then opened and the loose end of the fiber was inserted into the coils. The hair was placed adjacent to the locating pins then the spring was gently released. A great deal of care was taken with the loading process to ensure the fiber was not twisted during loading or that it was not damaged by stretching. Once loaded, the hairs were examined under a dissecting stereo microscope.

### X-ray diffraction

Synchrotron SAXS experiments were carried out at the Advanced Photon Source at the Argonne National Laboratory, USA. Analyses were conducted using the beamlines 18-ID (BioCAT) and 15-ID (ChemMatCARS).

The beam characteristics for the BioCAT experiment was 70 μm in the vertical and 200 μm in the horizontal and wavelength λ=1.03 Å. The hairs were mounted with the axis of the hair in the parallel plane and at a zero angle of incidence. The sample's optimal position in the beam was determined by use of a COD detector (Aviex Electronics, USA). The fiber was exposed to X-rays for 2 seconds and the diffraction image assessed for characteristic features that indicate if the fiber is centrally located in the beam. Once optimally located, the fiber was exposed to X-rays for approximately 20 seconds and the diffraction image collected on Fuji BAS III image plates that had an active area of approximately 190 mm×240 mm. The space between the sample and detector was held under vacuum to reduce air scattering, and this distance was determined to be 959.4 mm by analysis of the scattering pattern of Silver Behenate.

The beam characteristics used for the ChemMatCARS experiment was 300 μm in the vertical and 500 μm in the horizontal and the wavelength used was λ=1.50 Å. This translated to lower beam flux at the sample and hence longer sample exposure times but it facilitated sample positioning as the hair was fully encompassed within the X-ray beam. Hair samples were exposed to the X-ray source for 60 seconds and the diffraction images were collected on a MAR345 detector. The space between the sample and detector was held under vacuum to reduce air scattering, and this distance was determined to be 635.8 mm by analysis of the scattering pattern of Silver Behenate.

### Image Analysis

Diffraction images were analysed using FIT2D and Saxs15ID software packages. Both programs offer the data manipulation and smoothing routines that are required to perform the data reduction and subsequent analysis. Extracted one dimensional data from these packages was visualized and analysed using the Spectrum Viewer software package.

Two methods and parameters were employed to enhance the SAXS image by smoothing and subsequent background removal. The first one, which we hereinafter call the “Standard Protocol”, is known to have only been described in one publication by James (Reference: Wilk K, James V, and Amemiya Y. Intermediate Filament Structure of Human Hair. Biophysica Biochimica Acta. 1995; 1245: 392-396). In no publication by James does she describe the complete recipe of how to process the raw SAXS data and the parameters used to detect the presence of cancer. No previous publication contains a complete method that could be used by an independent observer to determine the incidence of breast cancer from a SAXS image. Whether or not the parameters and methods used to process the SAXS images by James have been developed since first published is unknown, but a clear and concise description of the complete method to process the SAXS images to diagnose breast cancer remains unpublished. In brief, smoothing the raw SAXS image is achieved by replacing the value of the central pixel of a 3 by 3 box of pixels with the average value calculated over that box. A background image is created by blurring the smoothed image in a similar manner to that described above but with a 20 by 20 box of pixels. The image used for the diagnosis of breast cancer is produced by subtracting the created background image from the smoothed image. The purpose of background correction is to remove the rising intensity at lower values of Q without compromising any of the features present in the original image. FIT2D has two different smoothing functions available to the user, “Smooth” and “Median”.

In the course of this study We developed an alternative background correction protocol to attempt to smooth the raw data and to produce a background image that, when subtracted from the smoothed data, did not remove or occlude important features which were present at low intensity in the original image. The SAXS images were initially smoothed using a 3 by 3 pixel “median” filtering operation, which allows smoothing without loss of subtle features, followed by a 50 by 50 pixel “averaging” to create a background from the smoothed image. We refer to this as the “Alternative Protocol”.

One-dimensional data was extracted from each SAXS image to determine the exact spacing of features in the image. This was achieved by two different methods. The first was to extract the intensity data along a single line starting from the centre of the image along the meridional plane at 0°, 60°, 120°, 180°, 240° and 300°. This process was used to ensure that if a ring was present in the SAXS image, the intensity data would show a peak in the appropriate location and from the analysis of the data from all four quadrants its circular nature could be established. For SAXS images that demonstrated weak features at the approximate spacing of the ring indicative to the presence of breast cancer, a modification to the method of data extraction described above was used. In these cases intensity data was extracted by integrating 5° sectors at the locations to the meridional mentioned above. This was performed in an attempt to increase the level of signal over background noise of weak data.

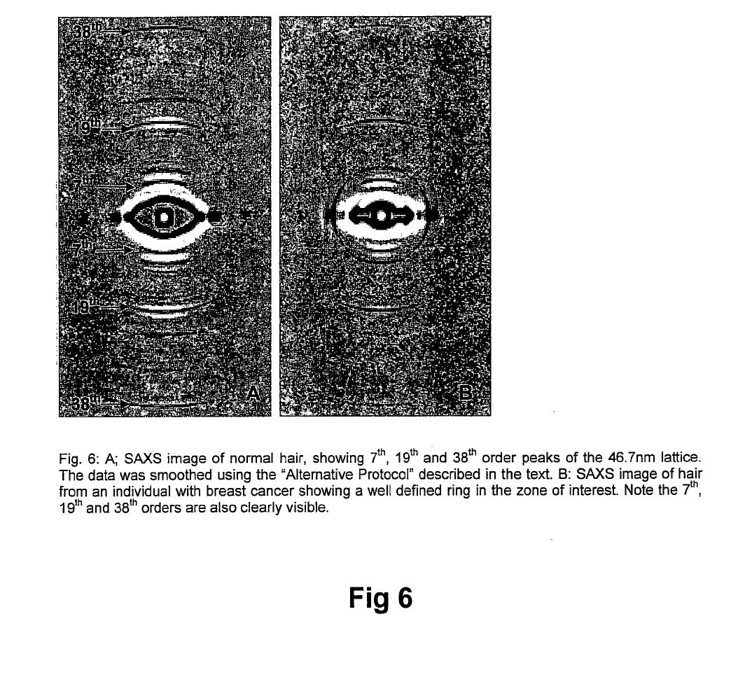

With reference to FIG. 6:

### Defining the Breast Cancer SAXS Pattern

Using the Standard Protocol for image processing we were able to identify the ring correlating to the presence of breast cancer in 13 of the 14 positive controls at the defined spacing (Q=0.133 Å⁻¹). None of the samples assumed negative by mammography demonstrated a ring at that spacing in their respective SAXS patterns. One-dimensional data extracted from the respective SAXS patterns confirmed the above findings.

The Standard protocol was then used to assess the blinded samples that were collected at the radiology clinic. The patient's pathology and results of the analyses using the Standard Protocol are shown in Table 1. From the information presented in the Table it can be seen that only 1 of the 19 samples collected came from a woman with confirmed breast cancer. Analysis of the SAXS pattern for this particular sample using the Standard Protocol produced an image with only a very faint and slightly elliptical ring in the zone of interest. One-dimensional data extracted from this image indicated the presence of a ring but was not significant above the background and was therefore designated as negative. After the samples were unblinded, this result was classified as a false negative. Of the other samples, three showed a ring in the zone of interest and were designated positive and another showed a ring in the zone of interest and also displayed evidence of disorder but was still designated positive. The other samples were declared negative.

From the SAXS analysis results generated using the Standard Protocol, it was apparent that the disclosed methodology and parameters used by James for image processing were not suited to images that contain weak and/or diffuse features.

We subsequently reanalysed the images using the Alternative Protocol of data reduction to ensure that faint but significant information in the area of interest was not lost as a result of image processing.

Using Fit2D and Sax15ID with the Alternative Protocol, the positive control samples were reassessed. From these results, and the extracted one dimensional data, we determined the spacing of the ring correlating to the presence of breast cancer to be Q=0.132±0.001 Å-1. The mean±2SDs was applied as the key quantitative criterion to define the zone of interest. Use of the Alternative Protocol produced superior and more detailed SAXS images compared to those of the Standard Protocol. FIGS. 6A and 6B are the resultant images from applying the Standard Protocol and the Alternative Protocol respectively to the sample designated negative and later classified as a false negative. As can be seen in FIG. 6B, a weak diffuse ring can now be seen. The one dimensional data extracted from this image defined the ring to have an approximate spacing of Q=0.132±0.002 Å-1 (d=4.76±0.07 nm). Thus the Alternative Protocol of image reduction produced superior data where diffuse low intensity information was observed.

TABLE 1
Comparison of SAXS data with mammography results in a set of patients attending a radiology clinic

| | | | Standard Protocol | Alternative Protocol |
|---|---|---|---|---|
| Code # | Clinic procedure | Patient notes | (blinded analysis) | (unblinded) |
| 40761 | Biopsy | Negative | Negative | Negative |
| | | Calcium oxalate | (ring at 0.137) | |
| 248057 | Mammography/ | Negative | Negative | Negative |
| | ultrasound/Biopsy | Benign breast tissue | (no ring) | (no ring) |
| 594776 | Biopsy | Positive | [symbol] | Positive |
| | | Infiltrating carcinoma | | (ring at 0.130) |
| 631895 | Mammography/ | Negative | Negative | Negative |
| | ultrasound | | (no ring) | (no ring) |
| 664921 | Mammography/ | Negative | Negative | Negative |
| | ultrasound | | (no ring) | (no ring) |
| 966848 | Mammography/ | Negative | Negative | Negative |
| | ultrasound | Cysts | (no ring) | |
| 6169711 | Ultrasound | Negative | [symbol] | Disorder |
| | | 3 mm Cyst | | |
| 9007130 | Mammography/ | Negative | Negative | Negative |
| | ultrasound | Fibroadenoma | (ring at 0.138) | (ring at 0.137) |
| 9008728 | Mammography | Negative | Negative | Negative |
| | | | Disordered (no ring) | (no ring) |
| 9025794 | Mammography/ | Negative | [symbol] | [symbol] |
| | ultrasound | | | |
| 9030217 | Mammography/ | Negative | Negative | Disorder |
| | ultrasound | Calcific foci | (strong ring at 0.130) | |
| 9033550 | Mammography | Negative | Disorder | Disorder |
| | | Mammary implants | (ring at 0.130) | Ring at 0.130 + |
| | | | | orders |
| 9039174 | Mammography/ | Negative | Negative | Negative |
| | ultrasound | Multiple cysts | (very faint/no ring) | (no ring) |
| 9076831 | Mammography | Negative | [symbol] | [symbol] |
| | | Post-surgical deformity | | |
| | | and benign calcific foci | | |
| 9079870 | Ultrasound | Negative | Negative | Negative |
| | | Cyst | (non-continuous | (Faint non-continuous |
| | | | feature at 0.140) | diffuse feature at 0.129) |
| 9085332 | Mammography/ | Negative | Disorder | Disorder |
| | ultrasound | | | |
| 9091902 | Mammography/ | Negative | Negative | Negative |
| | ultrasound | | (no ring) | (no ring) |
| 9126504 | Mammography/ | Negative | [symbol] | [symbol] |
| | ultrasound | Post-surgical deformity | | |
| | | and multiple cysts | | |
| 9235226 | Mammography | Negative | Disorder | Disorder |
| | | Probable cysts | | |

[symbol]

indicates data missing or illegible when filed

The above describes only some embodiments of the present invention and modifications, obvious to those skilled in the art, can be made thereto without departing from the scope of the present invention.

1. A method for automatically aligning a sample comprising a hair fiber within an x-ray beam, said sample mounted on a positioning device, said hair fiber comprising a linear arrangement of filamentary elements, said method comprising the steps of:
a. providing a sample, said sample mounted on a sample holding device having provisions for multiple separate samples to be mounted, each sample being uniquely identified;
b. providing an apparatus capable of viewing said mounted sample, whereby said apparatus is capable of imaging said mounted sample, reading the sample identifier and determining coordinates of said sample relative to a reference position, wherein no portion of said sample mounted in said positioning device is initially at said reference position;
c. providing a source of power for adjusting said positioning device linearly along at least two orthogonal axes;
d. activating said source of power to cause said positioning device to be adjusted such that said sample is positioned into the path of a beam of X-rays. whereby the said filamentary elements of said sample are aligned perpendicular to the path of said beam of x-rays; and
e. analyzing the pattern of diffracted x-rays derived from interaction of said x-rays with the filamentary elements.

2. The method of claim 1, wherein said viewing apparatus is a CCD camera.

3. (canceled)

4. A method for conducting single or multiple X-ray diffraction analysis on a sample selected from a plurality of samples, said sample consisting of a hair fiber, said hair fiber comprising a linear arrangement of filamentary elements, said method comprising the steps of:
a. collecting a hair from a subject using a sample collection device;
b. transporting the sample collection device containing the hair samples to an analysis facility;
c. mounting the hair in a sample holder;
d. providing a positioning device for mounting said sample holder so that said sample can be positioned in the path of a beam of X-rays;
e. providing an apparatus capable of viewing said mounted sample, whereby said apparatus is capable of imaging said mounted sample and determining coordinates of said sample relative to a reference position, wherein no portion of said sample mounted in said positioning device is initially at said reference position;
f. providing a source of power for adjusting said positioning device linearly along two or more orthogonal axes;
g. activating said source of power to cause said positioning device to be adjusted such that said sample is positioned into the path of a beam of X-rays;
h. providing a beam of X-rays, said beam aimed at said sample;
i. recording scattering of X-rays from said sample. whereby the said filamentary elements of said sample are aligned perpendicular to the path of said beam of x-rays; and
j. analyzing the pattern of diffracted x-rays derived from interaction of said x-rays with the filamentary elements

5. The method of claim 4, wherein said positioning device is connected to a motorized armature capable of movement in two or more planes;

6. (canceled)

7. (canceled)

8. (canceled)

9. (canceled)

10. (canceled)

11. A sample analysis system; said system comprising at least one sample array, an automated drive mechanism for urging a sample of said sample array to a first approximate location, and a monitoring and control system for adjustment of said drive mechanism to locate said sample into substantial coincidence with an X-ray diffraction beam; said hair fiber comprising a linear arrangement of filamentary elements; whereby the said filamentary elements of said sample are aligned perpendicular to the path of said beam of x-rays; analyzing the pattern of diffracted x-rays derived from interaction of said x-rays with the filamentary elements.

12. The system of claim 11 wherein said sample array comprises a number of discrete hair fibers retained in hair fiber holding means provided on a hair sample holding device; at least a portion of each of said fibers located in a common plane.

13. The system of claim 11 wherein said sample holding device comprises a plate of rigid material; said plate provided with a central elongate slot; said slot having raised ridges projecting from an outer face of said plate of rigid material; said ridged arranged along opposing elongate sides of said slot; said raised ridges defining said common plane.

14. The system of claim 13 wherein said hair fiber holding means include pairs of support posts disposed at intervals along said opposing elongate sides of said slot, a first one of each of said pairs of support posts arranged along one side of said slot and a second one of each of said pairs of support posts arranged along an opposite side of said slot; said posts projecting from the surface of said outer face sufficient to project beyond said common plane.

15. The system of claim 14 wherein each of said pairs of support posts is associated with a pair of extension coil springs; said coil springs tightly wound so as to provide retention force for ends of a said hair fiber; said hair fiber extending from a first of said pair of coil springs at one side of said elongate slot, to a second of said pair of coil springs at an opposite side of said slot; a middle portion of said hair fiber stretched over said pair of support posts.

16. The system of claim 12 wherein each of said hair fiber holding means is associated with a hair fiber identifying bar code label; said bar code label releasably affixed to said plate of rigid material adjacent said hair fiber holding means.

17. The system of claim 11 wherein said at least one sample array is one of a number of sample arrays retained in a sample array rack; said sample array rack supported on slide-ways adapted to allow translation of said sample array rack in two mutually orthogonal directions; said two mutually orthogonal directions lying in a plane parallel to said common plane and normal to said X-ray diffraction beam.

18. The system of claim 17 wherein said sample array rack is urged into said at least two orthogonal directions by servomotors of a computerized drive mechanism; said servomotors driving said sample array rack so as to position a said hair fiber at a said first approximate location between an X-ray beam emitter and an X-ray beam recording device.

19. The system of claim 11 wherein said first approximate location of a said hair fiber is compared to an optimum hair fiber location by means of an imaging system; said imaging system including software providing output to said computerized drive mechanism to position said middle portion of said hair fiber in substantial coincidence with said X-ray diffraction beam.

20. (canceled)

21. The system of claim 18 wherein said recording device is a MAR detector.

22. The system of claim 19 wherein said imaging system includes a CCD camera focused on said optimum hair fiber location at a point where said X-ray diffraction beam intersects said common plane.

23. The system of claim 18 wherein said system further includes a bar code reader, said bar code reader providing input to said computer for correlating a said hair fiber sample with a provider of said sample.

24. A method of analyzing a hair sample from a patient so as to improve sensitivity and specificity of a diagnostic test associated with a pathological state in the patient comprising: aligning the sample in accordance with the method of claim 1, then
a. exposing the hair sample to incident energy derived from an energy source;
b. receiving radiated energy from the hair sample consequent upon impingement of the incident energy on the keratin sample;
c. passing at least a portion of the radiated energy received from the hair sample through a transducer so as to derive data;
d. comparing the data derived with a second group of data present in a reference database;
wherein the second group of data is consistent with a presence of the pathological state in the patient.

25. The method of analyzing a hair sample as recited in claim 24 wherein the second group of data is correlated with the presence of the pathological state in the patient.

26. The method of analyzing a hair sample as recited in claim 24 wherein the second group of data is causatively associated with the presence of the pathological state in the patient.

27. (canceled)

28. (canceled)

29. (canceled)

30. (canceled)

31. (canceled)

32. The method of analyzing a hair sample as recited in claim 24 wherein, in use, the hair sample can be obtained and analyzed in association with at least one of a pharmacy, a test kit, the patient's home, a health care clinic or a pathology collection centre and a testing laboratory.

33. (canceled)

34. A method of analysis of the data derived in the method of claim 24 wherein said data is in the form of image data of an image derived from said transducer, said method of analysis comprising:
a. extracting one-dimensional data along predetermined paths in said image so as to determine spacing of features in said image;
b. defining substantially circular-oriented peak data about a centre point of said image from an analysis of said one-dimensional data; and
c. applying intensity correction to said substantially circular-oriented peak data so as to better define said circular-oriented peak data as it appears in said image.

35. A hair sample analysis system; said system comprising at least one sample array; said hair fiber comprising a linear arrangement of filamentary elements; an automated drive mechanism for urging a hair sample of said sample array to a first approximate location, and a monitoring and control system for adjustment of said drive mechanism to locate said sample into substantial coincidence with an X-ray diffraction beam; locating said sample in substantial coincidence with said X-ray diffraction beam; irradiating said sample with said beam for a predetermined time; receiving and storing for analysis data derived from said step of irradiating said hair sample; repeating said steps for a consecutive one of said samples from said sample array; whereby the said filamentary elements of said sample are aligned perpendicular to the path of said beam of x-rays; analyzing the pattern of diffracted x-rays derived from interaction of said x-rays with the filamentary elements

36. A hair sample analysis system; said system comprising multiple sample arrays located within a container, an automated drive mechanism for removing an individual array from said container and for urging a hair sample of said sample array to a first approximate location, and a monitoring and control system for adjustment of said drive mechanism to locate said sample into substantial coincidence with an X-ray diffraction beam; locating said sample in substantial coincidence with said X-ray diffraction beam; irradiating said sample with said beam for a predetermined time; receiving and storing for analysis data derived from said step of irradiating said sample; repeating said steps for a consecutive one of said samples from said sample array; returning said sample array to its original location in said container and removing another array from said sample container and repeating said steps for consecutive arrays.
